(19) United States
(12) Patent Application Publication
(10) Pub. No.: US 2026/0118595 A1
(43) Pub. Date: Apr. 30, 2026

(54) COUPLING COMPONENT FOR OPTICAL-FIBER CONNECTOR

(71) Applicant: ACON OPTICS COMMUNICATIONS INC., New Taipei City (TW)

(72) Inventors: Yang-Yang CUI, New Taipei City (TW); Ji-Lan AN, New Taipei City (TW)

(21) Appl. No.: 19/003,473

(22) Filed: Dec. 27, 2024

(30) Foreign Application Priority Data
Dec. 28, 2023 (CN) 202311839303.8

(51) Int. Cl. G02B 6/38

(52) U.S. Cl. CPC G02B 6/3849; G02B 6/3874; G02B 6/3893

(57) ABSTRACT

A coupling component for optical-fiber connector includes a coupling body, a core component, and a sleeve member. Two ends of the coupling body have an insertion side and an assembling side, respectively. The coupling body has a through hole running through the insertion side and the assembling side. The coupling body has a limiting opening at the insertion side and a mating opening at the assembling side. The limiting opening and the mating opening are in communication with each other through the through hole. The coupling body includes a stopping member extending outwards and at a side surface between the insertion side and the assembling side, the coupling body includes a base member at the assembling side, and the coupling body and the base member are integrated as a one-piece member. The core component includes a core member and an elastic member. The sleeve member is outside the base member.

### CROSS-REFERENCE TO RELATED APPLICATION

This non-provisional application claims priority under 35 U.S.C. § 119(a) to Patent Application No. 202311839303.8 filed in China, P.R.C. on December 28, 2023, the entire contents of which are hereby incorporated by reference.

### FIELD OF THE INVENTION

The instant disclosure relates to a coupling component, and more particular to a coupling component for optical-fiber connector.

### BACKGROUND

The optical fiber is an tool for optical transmission. An optical-fiber connector is used for connecting the optical fiber with different electronic devices, so that the electronic devices can utilize the signals transmitted by the optical fiber. A coupling component for optical-fiber connector known to the inventor includes a hollow body, a core component, a spring, a base member, and a sleeve member. After the hexagonal blocking member of the core component and the spring are assembled in the hexagonal through hole inside the hollow body, the base member is fixed at the side opening of the hollow body and thus the core component and the spring are limited by the base member, and then the sleeve member is assembled outside the base member. As a result, the hexagonal blocking member and the hexagonal through hole are not limited by each other easily, so that the core component will rotate with respect to the hollow body along an axial direction easily.

### SUMMARY OF THE INVENTION

In view of these, some embodiments of the instant disclosure provides an optical-fiber connector in which the coupling body and the base member are integrated as a one-piece member, and the optical-fiber connector comprises a core component which is assembled in the through hole from the limiting opening of the coupling body.

According to some embodiments, a coupling component for optical-fiber connector comprises a coupling body, a core component, and a sleeve member. One of two ends of the coupling body has an insertion side, and the other end of the coupling body has an assembling side. The coupling body has a through hole running through the insertion side and the assembling side. The coupling body has a limiting opening at the insertion side, the coupling body has a mating opening at the assembling side, and the limiting opening and the mating opening are in communication with each other through the through hole. The coupling body comprises a stopping member extending outwards and at a side surface between the insertion side and the assembling side, the coupling body comprises a base member at the assembling side. The core component comprises a core member and an elastic member which are assembled in the through hole from the limiting opening. The sleeve member is outside the base member.

In some embodiments, the coupling body and the base member are integrated as a one-piece member.

In some embodiments, the coupling body is a hollow rectangular structure, the base member is a hollow cylindrical structure, the mating opening is at the base member, and a hole diameter of the limiting opening at the insertion side is greater than a hole diameter of the mating opening at the assembling side.

In some embodiments, the core member comprises an insertion pin, a blocking member, and a connection sleeve. The insertion pin and the connection sleeve are respectively at two sides of the blocking member, the insertion pin is at one of two ends of the coupling body along a long side direction of the coupling body and corresponds to the limiting opening, the connection sleeve is at the other end of the coupling body along the long side direction of the coupling body and corresponds to the mating opening, and the elastic member is outside the connection sleeve.

In some embodiments, the limiting opening is rectangular, the through hole is rectangular and has four leaning surfaces, the blocking member is rectangular and has four limiting surfaces, and each of the leaning surfaces corresponds to a corresponding one of the limiting surfaces.

In some embodiments, one of two ends of the elastic member along the long side direction of the coupling body contacts the blocking member, the coupling body comprises a stopping wall in the through hole, and the other end of the elastic member along the long side direction of the coupling body contacts the stopping wall.

In some embodiments, the coupling body comprises a mating block in the through hole, the core member comprises a buckling block at an outer peripheral surface of the connection sleeve, and the mating block contacts the buckling block.

In some embodiments, each of two opposite sides of a horizontal line of the buckling block has a flat surface, and each of two opposite sides of a vertical line of the buckling block has a curved surface.

In some embodiments, each of two sides of a vertical line of the base member comprises a hook portion, the hook portions protrude toward opposite directions, the sleeve member has a via and an annular groove at an inner wall of the via, and the hook portions are in the annular groove.

In some embodiments, the coupling component further comprises a cap, and the cap is at the limiting opening.

In some embodiments, one of two ends of the stopping member has a fixed end, and the other end of the stopping member has a free end. The fixed end is at the insertion side and at one of two sides of the side surface of the coupling body, the free end is at the assembling side and at the other end of the side of the coupling body, and the stopping member obliquely extends away from the side surface of the coupling body along a direction from the fixed end toward the free end.

According to some embodiments of the instant disclosure, through the configuration that the coupling body and the base member are integrated as a one-piece member, the structural strength of the coupling component can be increased, and the coupling component can be prevented from being broken, especially from the portion between the coupling body and the base member. Moreover, the core component can be assembled in the through hole from the limiting opening of the coupling body, such that the core component can be properly positioned in the through hole.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a coupling component according to some embodiments of the instant disclosure;

FIG. 2 illustrates a front exploded view of the coupling component according to some embodiments of the instant disclosure;

FIG. 3 illustrates a rear exploded view of the coupling component according to some embodiments of the instant disclosure;

FIG. 4 illustrates a perspective sectional view of the coupling body according to some embodiments of the instant disclosure;

FIG. 5 illustrates a perspective view of the core member according to some embodiments of the instant disclosure; and

FIG. 6 illustrates a cross-sectional view of the coupling component according to some embodiments of the instant disclosure.

### DETAILED DESCRIPTION

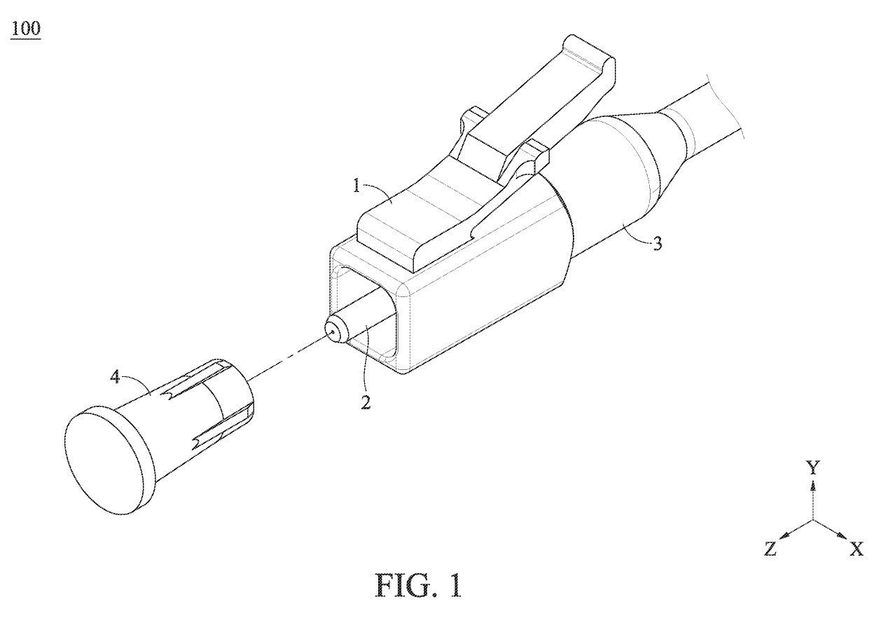

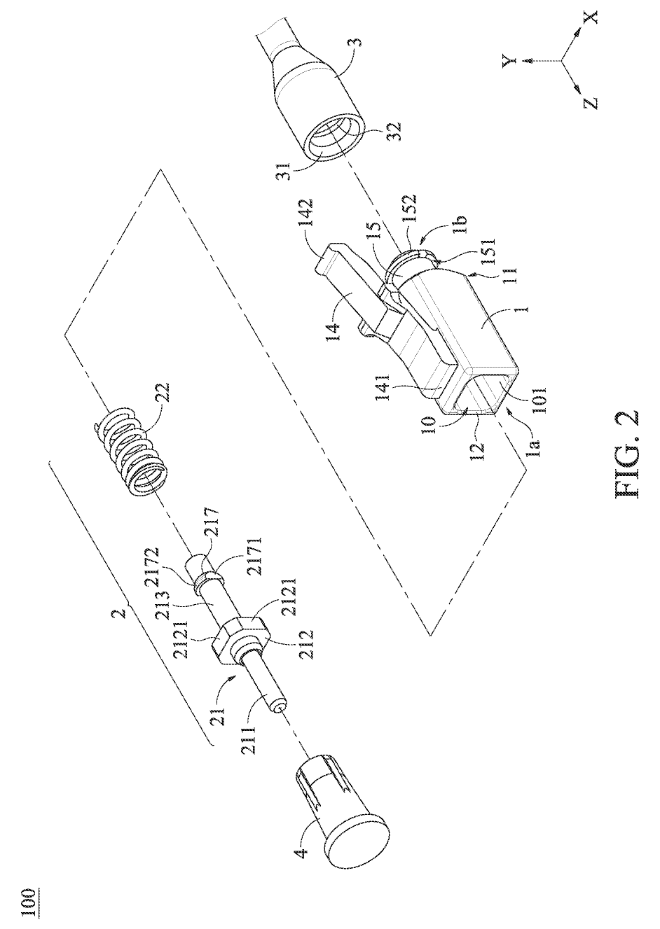

Please refer to FIG. 1 and FIG. 2. FIG. 1 illustrates a perspective view of a coupling component 100, and FIG. 2 illustrates a front exploded view of the coupling component 100. In some embodiments, the coupling component 100 is adapted to an optical-fiber connector which can be utilized in electrocommunication, interior wiring, industry, military, aerospace, medical devices, or other applications in high-temperature/low-temperature environments, and the optical-fiber connector can be utilized for devices of data center, 5G, cloud computing, or the like. The optical-fiber connector is a high density optical-fiber connection device adapted to provide high speed signal transmission. The optical-fiber connector is a product for optical telecommunication and has insertion openings for optical-fiber cables so as to receive several core wires of the optical-fiber cables (transmission and reception). The coupling component 100 comprises a coupling body 1, a core component 2, and a sleeve member 3.

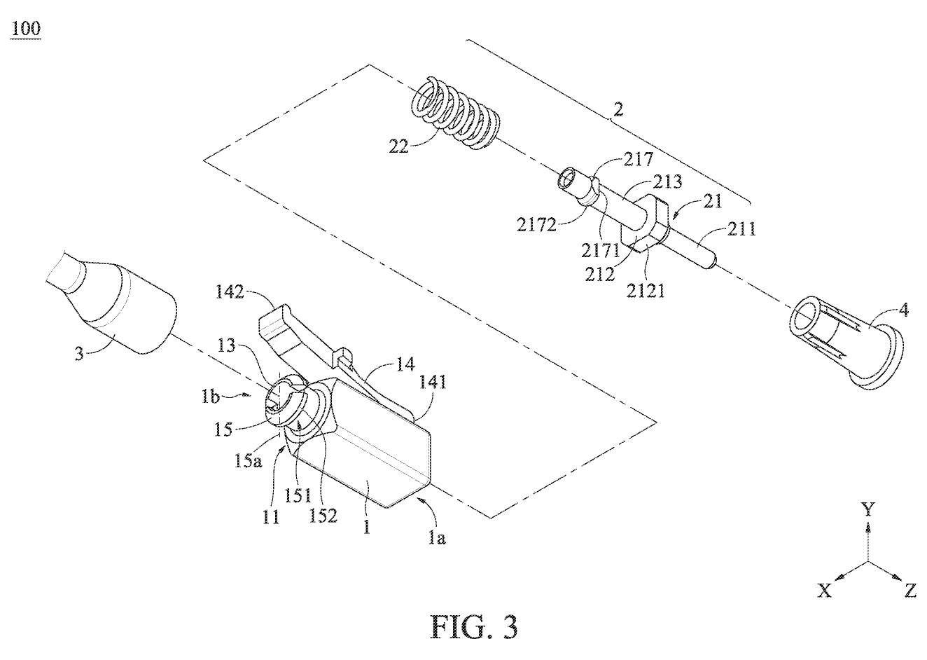

Please refer to FIG. 2 and FIG. 3. FIG. 3 illustrates a rear exploded view of the coupling component 100. One of two ends of the coupling body 1 has an insertion side 1a, and the other end of the coupling body 1 has an assembling side 1b. The insertion side 1a is at the left side of the coupling body 1 shown in FIG. 2, and the assembling side 1b is at the right side of the coupling body 1 shown in FIG. 2. The coupling body 1 has a through hole 10 running through the insertion side 1a and the assembling side 1b. The coupling body 1 has a limiting opening 12 at the insertion side 1a, the coupling body 1 has a mating opening 13 at the assembling side 1b, and the limiting opening 12 and the mating opening 13 are in communication with each other through the through hole 10. The coupling body 1 comprises a stopping member 14 extending outwards and at a side surface between the insertion side 1a and the assembling side 1b (for example, the upper surface of the coupling body 1 shown in FIG. 2). The coupling body 1 comprises a base member 15 at the assembling side 1b, and the coupling body 1 and the base member 15 are integrated as a one-piece member.

To illustrate the embodiments more clearly, in the drawings, the first axis X is the X axis of the three-dimensional coordinate system, the second axis Y is the Y axis of the three-dimensional coordinate system, and the third axis Z is the Z axis of the three-dimensional coordinate system.

The coupling body 1 is a hollow rectangular structure 11. As shown in FIG. 2, the coupling body 1 extends along the third axis Z direction and has four side surfaces opposite to each other to be enclosed as a rectangular structure, and the coupling body 1 extends along the first axis X direction and has two side surfaces opposite to each other. The two side surfaces along the first axis X direction are respectively connected to two of the four side surfaces along the third axis Z direction, the two side surfaces along the first axis X direction are side surfaces of the coupling body 1 along a short side direction of the coupling body 1, and the four side surfaces along the third axis Z direction are side surfaces of the coupling body 1 along a long side direction of the coupling body 1. The limiting opening 12 is at the left side surface of the coupling body 1 along the short side direction of the coupling body 1 shown in FIG. 2, and the mating opening 13 is formed at the left side surface of the base member 15 shown in FIG. 3. The base member 15 of the coupling body 1 is a hollow cylindrical structure 151, and the base member 15 protrudes from a side surface of the coupling body 1 along the short side direction of the coupling body 1 shown in FIG. 3.

In some embodiments, one of two ends of the stopping member 14 has a fixed end, 141 and the other end of the stopping member 14 has a free end 142. The fixed end 141 is at one of two ends of the side surface of the coupling body 1 (the left side of the upper surface of the coupling body 1 shown in FIG. 2), and the free end 142 is at the other end of the side surface of the coupling body 1 (the right side of the upper surface of the coupling body 1 shown in FIG. 2). In this embodiment, the stopping member 14 obliquely extends away from the negative third axis Z direction toward the positive second axis Y direction, namely, extends away from the side surface of the coupling body 1, along a direction from the fixed end 141 toward the free end 142. In this embodiment, it is understood that, as to the recitation of “the side surface of the coupling body 1 comprises the stopping member 14 extending outwards” the term “outwards” indicates that along a height direction perpendicular to the long side direction of the upper surface of the coupling body 1, and the stopping member 14 extends, from one of two ends of the coupling body 1 (the left side of the coupling body 1 shown in FIG. 1), along the negative third axis Z direction, toward the other end of the coupling body 1 (the right side of the coupling body 1 shown in FIG. 1), and toward the positive second axis Y direction. An angle between the stopping member 14 and the upper surface of the coupling body 1 is about 30 degrees.

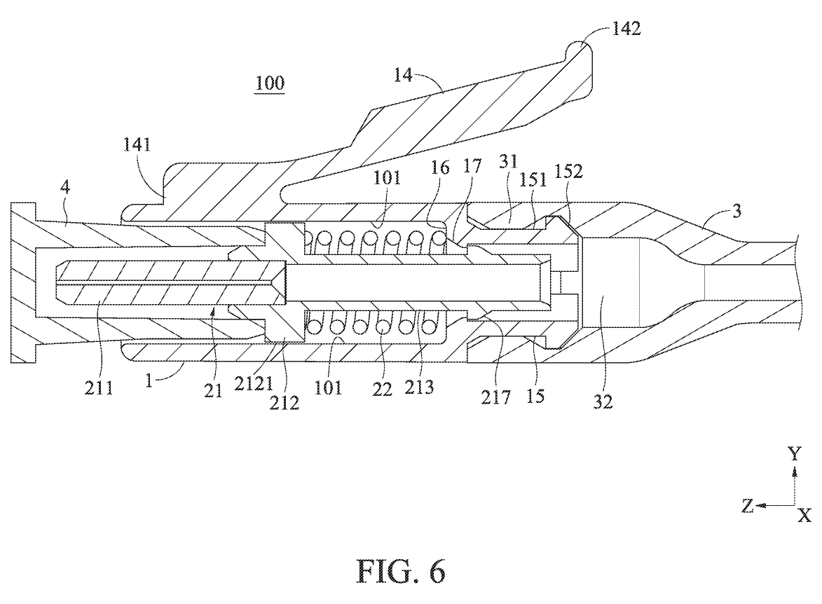

When the core component 2 is assembled with the coupling member 1, the core component 2 is assembled in the through hole 10 from the limiting opening 12, so that the elastic member 22 of the core component 2 is be limited in the through hole 10 of the coupling body 1. Next, the sleeve member 3 is fitted over the base member 15, so that the semi-product (as shown in FIG. 6) of the coupling component 100 can be completed. Moreover, a cap 4 may be assembled on the coupling body 1, so that the cap 4 is fixed at the limiting opening 12 to provide dustproof and protection function for the core component 2.

In some embodiments, the core member 21 comprises an insertion pin 211, a blocking member 212, and a connection sleeve 213. The insertion pin 211 and the connection sleeve 213 are respectively at two sides of the blocking member 212 along the third axis Z direction shown in FIG. 2. When the core member 21 and the elastic member 22 are assembled in the through hole 10 of the coupling body 1, the insertion pin 211 is at one of two ends of the coupling body 1 along the long side direction of the coupling body 1 and corresponds to the limiting opening 12, and the connection sleeve 213 is at the other end of the coupling body 1 along the long side direction of the coupling body 1 and corresponds to the mating opening 13. Moreover, the elastic member 22 is fitted over the connection sleeve 213 (as shown in FIG. 6). In some embodiments, the insertion pin 211 is adapted to enclose optical fiber cables, and the optical fiber cables are aligned with the core hole of the insertion pin 211.

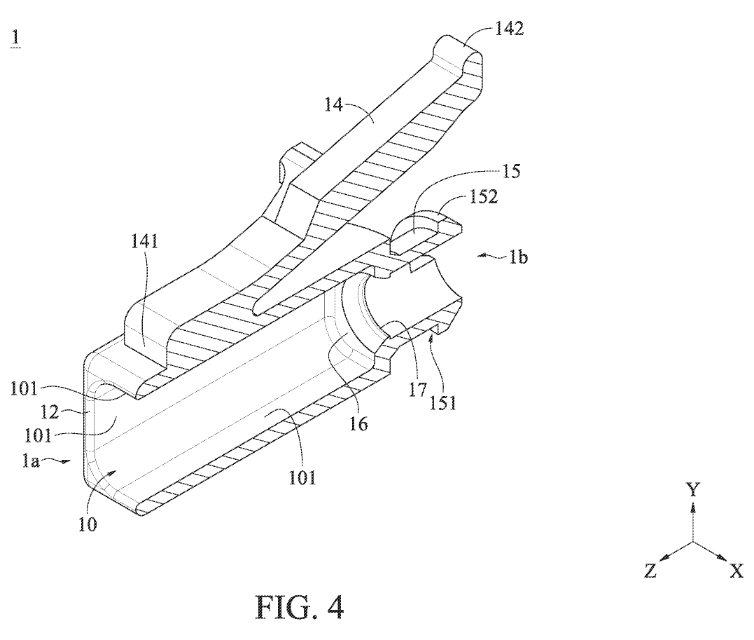

Please refer to FIG. 2 to FIG. 4. FIG. 4 illustrates a perspective sectional view of the coupling body 1. In some embodiments, a hole diameter of the limiting opening 12 and a hole diameter of the mating opening 13 of the coupling body 1 are different; in some embodiments, the hole diameter of the limiting opening 12 at the insertion side 1a is greater than a hole diameter of the mating opening 13 at the assembling side 1b. In some embodiments, viewing from the negative third axis Z direction shown in FIG. 2, the limiting opening 12 of the coupling body 1 is rectangular, and the through hole 10 in the coupling body 1 is also rectangular. The through hole 10 has four leaning surfaces 101 which extend along the third axis Z direction and are enclosed as a rectangular structure, and a rounded corner is between two adjacent leaning surfaces 101. Furthermore, viewing from the positive third axis Z direction shown in FIG. 3, the mating opening 13 of the coupling body 1 is round.

In some embodiments, viewing from the negative third axis Z direction shown in FIG. 2, the blocking member 212 is rectangular and has four limiting surfaces 2121. Two of the four limiting surfaces 2121 are opposite to each other and arranged along the first axis X direction, and the rest two of the four limiting surfaces 2121 are opposite to each other and arranged along the second axis Y direction. A rounded corner is between two adjacent limiting surfaces 2121.

When the core member 21 is assembled in the through hole 10 of the coupling body 1, each of the limiting surfaces 2121 of the blocking member 212 of the core member 21 corresponds to a corresponding one of the leaning surfaces 101 at an inner wall of the through hole 10. Therefore, the four leaning surfaces 101 and the four limiting surfaces 2121 are attached with and positioned with each other in a face-to-face manner, and the core member 21 is limited in the through hole 10 and thus cannot be rotated freely with respect to the coupling body 1 along an axial direction.

In some embodiments, when the elastic member 22 is assembled in the through hole 10 of the coupling body 1, one of two ends of the elastic member 22 along the long side direction of the coupling body 1 contacts the blocking member 212. Moreover, the coupling body 1 comprises a stopping wall 16 in the through hole 10, and the other end of the elastic member 22 along the long side direction of the coupling body 1 contacts the stopping wall 16 (as shown in FIG. 6).

When the core member 21 is to be mated with a mating component, the insertion pin 211 of the core member 21 is moved rightwards (toward the negative third axis Z direction shown in FIG. 6), and the blocking member 212 compresses one of two ends of the elastic member 22, so that the elastic member 22 is compressed, and then the insertion pin 211 of the core member 21 is pushed by the resilient force of the elastic member 22 to be moved leftwards (toward the positive third axis Z direction shown in FIG. 6).

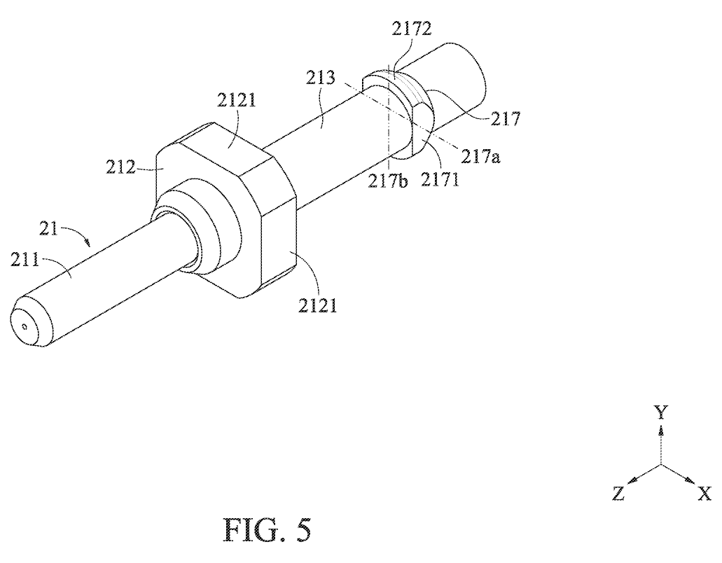

Please refer to FIG. 4 to FIG. 6. FIG. 5 illustrates a perspective view of the core member 21. FIG. 6 illustrates a cross-sectional view of the coupling component 100. As mentioned, in order to prevent the insertion pin 211 of the core member 21 being ejected out of the limiting opening 12, in some embodiments, the coupling body 1 comprises a mating block 17 in the through hole 10, and viewing from the negative third axis Z direction shown in FIG. 4, the mating block 17 is substantially an inward-protruding annular structure. The core member 21 comprises a buckling block 217 at an outer peripheral surface of the connection sleeve 213, and viewing from the negative third axis Z direction shown in FIG. 5, the buckling block 217 is substantially an outward-protruding annular structure. The mating block 17 and the buckling block 217 are reversed hook structures extending along opposite directions. An inclined surface of the mating block 17 faces an inclined surface of the buckling block 217, and a vertical surface of the mating block 17 is opposite to a vertical surface of the buckling block 217. When the core member 21 is assembled in the through hole 10 of the coupling body 1, the buckling block 217 at the outer peripheral surface of the connection sleeve 213 is engaged with the mating block 17. In other words, in some embodiments, the vertical surface of the buckling block 217 is engaged with the vertical surface of the mating block 17, so that the buckling block 217 is limited by the mating block 17, and the core member 21 thus cannot be moved toward the limiting opening 12. Therefore, the insertion pin 211 of the core member 21 can be prevented from being ejected out of the limiting opening 12 leftwards (toward the positive third axis Z direction shown in FIG. 6).

Please refer to FIG. 2 and FIG. 5. In some embodiments, each of two opposite sides of a horizontal line 217a of the buckling block 217 along the first axis X direction has a flat surface 2171, and each of two opposite sides of a vertical line 217b of the buckling block 217 along the second axis Y direction has a curved surface 2172. When the core member 21 is assembled in the through hole 10 of the coupling body 1, the curved surface 2172 of the buckling block 217 contacts the mating block 17 of the coupling body 1, so that the curved surface 2172 guides the buckling block 217 to be moved from one of two sides of the mating block 17 to the other side of the mating block 17 along the third axis Z direction shown in FIG. 6.

In some embodiments, each of two sides of a vertical line 15a of the base member 15 of the coupling body 1 along the second axis Y direction shown in FIG. 3 comprises a hook portion 152, and the hook portions 152 are spaced from each other and protrude toward opposite directions; in other words, in some embodiments, the hook portions 152 protrude outwards toward the positive second axis Y direction and the negative second axis Y direction from the vertical line 15a, respectively. In some embodiments, the sleeve member 3 has a via 31 and an annular groove 32 at an inner wall of the via 31. When the sleeve member 3 is fitted over the base portion 15 along the third axis Z direction shown in FIG. 2, the hook portions 152 are squeezed by the inner wall of the sleeve member 3, so that the hook portions 152 are moved closer to each other to allow the base portion 15 to be assembled with the annular groove 32 of the sleeve member 3 conveniently. When the hook portions 152 are placed in the annular groove 32 of the sleeve member 3, because of the space provided by the annular groove 32, the hook portions 152 can be moved away from each other and moved resiliently to original positions, so that the hook portions 152 can be engaged with the inner wall of the annular groove 32, thereby allowing the sleeve member 3 to be positioned outside the base portion 15.

According to some embodiments of the instant disclosure, through the configuration that the coupling body and the base member are integrated as a one-piece member, the structural strength of the coupling component can be increased, and the coupling component can be prevented from being broken, especially from the portion between the coupling body and the base member. Moreover, the core component can be assembled in the through hole from the limiting opening of the coupling body, such that the core component can be properly positioned in the through hole.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A coupling component for optical-fiber connector, comprising:
a coupling body, wherein one of two ends of the coupling body has an insertion side, and the other end of the coupling body has an assembling side, the coupling body has a through hole running through the insertion side and the assembling side, the coupling body has a limiting opening at the insertion side, the coupling body has a mating opening at the assembling side, the limiting opening and the mating opening are in communication with each other through the through hole, the coupling body comprises a stopping member extending outwards and at a side surface between the insertion side and the assembling side, the coupling body comprises a base member at the assembling side, and the coupling body and the base member are integrated as a one-piece member;
a core component comprising a core member and an elastic member, wherein the core member and the elastic member are assembled in the through hole from the limiting opening; and
a sleeve member outside the base member.

2. The coupling component for optical-fiber connector according to claim 1, wherein the coupling body is a hollow rectangular structure, the base member is a hollow cylindrical structure, the mating opening is at the base member, and a hole diameter of the limiting opening at the insertion side is greater than a hole diameter of the mating opening at the assembling side.

3. The coupling component for optical-fiber connector according to claim 2, wherein the core member comprises an insertion pin, a blocking member, and a connection sleeve, the insertion pin and the connection sleeve are respectively at two sides of the blocking member, the insertion pin is at one of two ends of the coupling body along a long side direction of the coupling body and corresponds to the limiting opening, the connection sleeve is at the other end of the coupling body along the long side direction of the coupling body and corresponds to the mating opening, and the elastic member is outside the connection sleeve.

4. The coupling component for optical-fiber connector according to claim 3, wherein the limiting opening is rectangular, the through hole is rectangular and has four leaning surfaces, the blocking member is rectangular and has four limiting surfaces, and each of the leaning surfaces corresponds to a corresponding one of the limiting surfaces.

5. The coupling component for optical-fiber connector according to claim 3, wherein one of two ends of the elastic member along the long side direction of the coupling body contacts the blocking member, the coupling body comprises a stopping wall in the through hole, and the other end of the elastic member along the long side direction of the coupling body contacts the stopping wall.

6. The coupling component for optical-fiber connector according to claim 3, wherein the coupling body comprises a mating block in the through hole, the core member comprises a buckling block at an outer peripheral surface of the connection sleeve, and the mating block contacts the buckling block.

7. The coupling component for optical-fiber connector according to claim 6, wherein each of two opposite sides of a horizontal line of the buckling block has a flat surface, and each of two opposite sides of a vertical line of the buckling block has a curved surface.

8. The coupling component for optical-fiber connector according to claim 1, wherein each of two sides of a vertical line of the base member comprises a hook portion, the hook portions protrude toward opposite direction, the sleeve member has a via and an annular groove at an inner wall of the via, and the hook portions are in the annular groove.

9. The coupling component for optical-fiber connector according to claim 1, further comprising a cap, wherein the cap is at the limiting opening.

10. The coupling component for optical-fiber connector according to claim 1, wherein one of two ends of the stopping member has a fixed end, the other end of the stopping member has a free end, the fixed end is at the insertion side and at one of two sides of the side surface of the coupling body, the free end is at the assembling side and at the other end of the side of the coupling body, and the stopping member obliquely extends away from the side surface of the coupling body along a direction from the fixed end toward the free end.

11. A coupling component for optical-fiber connector, comprising:
a coupling body, wherein one of two ends of the coupling body has an insertion side, and the other end of the coupling body has an assembling side, the coupling body has a through hole running through the insertion side and the assembling side, the coupling body has a limiting opening at the insertion side, the coupling body has a mating opening at the assembling side, the limiting opening and the mating opening are in communication with each other through the through hole, the coupling body comprises a stopping member extending outwards and at a side surface between the insertion side and the assembling side, and the coupling body comprises a base member at the assembling side;
a core component comprising a core member and an elastic member, wherein the core member and the elastic member are assembled in the through hole from the limiting opening; and
a sleeve member outside the base member.

12. The coupling component for optical-fiber connector according to claim 11, wherein the coupling body is a hollow rectangular structure, the base member is a hollow cylindrical structure, the mating opening is at the base member, and a hole diameter of the limiting opening at the insertion side is greater than a hole diameter of the mating opening at the assembling side.

13. The coupling component for optical-fiber connector according to claim 12, wherein the core member comprises an insertion pin, a blocking member, and a connection sleeve, the insertion pin and the connection sleeve are respectively at two sides of the blocking member, the insertion pin is at one of two ends of the coupling body along a long side direction of the coupling body and corresponds to the limiting opening, the connection sleeve is at the other end of the coupling body along the long side direction of the coupling body and corresponds to the mating opening, and the elastic member is outside the connection sleeve.

14. The coupling component for optical-fiber connector according to claim 13, wherein the limiting opening is rectangular, the through hole is rectangular and has four leaning surfaces, the blocking member is rectangular and has four limiting surfaces, and each of the leaning surfaces corresponds to a corresponding one of the limiting surfaces.

15. The coupling component for optical-fiber connector according to claim 13, wherein one of two ends of the elastic member along the long side direction of the coupling body contacts the blocking member, the coupling body comprises a stopping wall in the through hole, and the other end of the elastic member along the long side direction of the coupling body contacts the stopping wall.

16. The coupling component for optical-fiber connector according to claim 13, wherein the coupling body comprises a mating block in the through hole, the core member comprises a buckling block at an outer peripheral surface of the connection sleeve, and the mating block contacts the buckling block.

17. The coupling component for optical-fiber connector according to claim 16, wherein each of two opposite sides of a horizontal line of the buckling block has a flat surface, and each of two opposite sides of a vertical line of the buckling block has a curved surface.

18. The coupling component for optical-fiber connector according to claim 11, wherein each of two sides of a vertical line of the base member comprises a hook portion, the hook portions protrude toward opposite direction, the sleeve member has a via and an annular groove at an inner wall of the via, and the hook portions are in the annular groove.

19. The coupling component for optical-fiber connector according to claim 11, further comprising a cap, wherein the cap is at the limiting opening.

20. The coupling component for optical-fiber connector according to claim 11, wherein one of two ends of the stopping member has a fixed end, the other end of the stopping member has a free end, the fixed end is at the insertion side and at one of two sides of the side surface of the coupling body, the free end is at the assembling side and at the other end of the side of the coupling body, and the stopping member obliquely extends away from the side surface of the coupling body along a direction from the fixed end toward the free end.
